(19) United States
(12) Patent Application Publication
(10) Pub. No.: US 2025/0317449 A1
(43) Pub. Date: Oct. 9, 2025

(54) PROOF OF LOCALITY FOR GUEST ACCESS

(71) Applicant: Apple Inc., Cupertino, CA (US)

(72) Inventors: Keith W. Rauenbuehler, San Francisco, CA (US); Andreas I. Gal, San Mateo, CA (US); Kuldeep R. Modi, San Jose, CA (US)

(73) Assignee: Apple Inc., Cupertino, CA (US)

(21) Appl. No.: 19/171,767

(22) Filed: Apr. 7, 2025

Related U.S. Application Data
(60) Provisional application No. 63/631,411, filed on Apr. 8, 2024.

(51) Int. Cl. H04L 9/40

(52) U.S. Cl. CPC H04L 63/107; H04L 63/083

(57) ABSTRACT

Techniques are disclosed for receiving, by a first device connected to a network from a user device, a first locality credential indicating that the user device is within a first locality. The techniques further including obtaining, by the first device, a second locality credential indicating that the user device is within a second locality. The techniques further including determining, by the first device, whether the first locality credential is trusted based at least in part on a comparison of the first locality to the second locality. The techniques further including in accordance with a determination that the first locality credential is trusted, enabling, by the first device, the user device to access the network associated with the first device.

### CROSS-REFERENCES TO RELATED APPLICATIONS

This application claims the benefit of and priority to U.S. Provisional Application No. 63/631,411, filed on Apr. 8, 2024, the contents of which is incorporated by reference in its entirety for all purposes.

### BACKGROUND

Techniques exist for permitting guests access to resources and taking away guest's access to resources of a resource owner. For example, a resource owner (e.g., homeowner) may give a physical door key to a guest to permit access to a location (e.g., a home). In another example, a resource owner may give a Wi-Fi password to a guest to allow them to access devices on the owner's Wi-Fi network. In yet another example, a homeowner may remotely unlock a door for a guest when the homeowner believes the guest to be at their house so the guest can enter into the house. It can be complicated and burdensome to permit and revoke which guests can access certain resources of a resource owner, when guests can access the resources, and/or when guests cannot access the resources.

### BRIEF DESCRIPTION OF THE DRAWINGS

FIG. 1 is a simplified block diagram of an example system, according to some embodiments.

FIG. 2 is a simplified block diagram illustrating at least some example techniques for proving locality of a user device, according to some embodiments.

FIG. 3 is a simplified block diagram illustrating at least some example techniques for proving locality of a user device, according to some embodiments.

FIG. 4 is a simplified block diagram illustrating access control management based on proof of locality of a user device, according to some embodiments.

FIG. 5 is a simplified block diagram illustrating an example architecture of a system used to manage resource access based on proof of locality of a user device, according to some embodiments.

FIG. 6 is a simplified flow diagram illustrating an example process performed by a user device to prove locality, according to some embodiments.

FIG. 7 is a simplified flow diagram illustrating an example process performed by a resident device to manage access to a resource based on proof of locality, according to some embodiments.

FIG. 8 is a simplified flow diagram illustrating an example process performed by a verification device to verify a locality, according to some embodiments.

### DETAILED DESCRIPTION

In the following description, various examples will be described. For purposes of explanation, specific configurations and details are set forth in order to provide a thorough understanding of the examples. However, it will also be apparent to one skilled in the art that the examples may be practiced without the specific details. Furthermore, well-known features may be omitted or simplified in order not to obscure the example being described.

In an embodiment, techniques include receiving, by a first device connected to a network from a user device, a first locality credential indicating that the user device is within a first locality. The techniques further include obtaining, by the first device, a second locality credential indicating that the user device is within a second locality. The techniques further include determining, by the first device, whether the first locality credential is trusted based at least in part on a comparison of the first locality to the second locality. In accordance with a determination that the first locality credential is trusted, the techniques further include enabling, by the first device, the user device to access the network associated with the first device. In certain embodiments, the first locality credential is not trusted if the first locality is not a same locality as the second locality and in accordance with a second determination that the first locality credential is not trusted, the techniques further include disabling, by the first device, the access to the network.

wherein the method further comprises in accordance with a second determination that the first locality credential is not trusted, disabling, by the first device, the access to the network

Embodiments of the present disclosure can provide techniques for managing access to resources. Certain techniques described herein can enable a user to obtain access to a resource based on where the user is. A resource may be tangible or intangible. For example, a resource may be a location, an item, a file, a network, an environment device, and/or a service. Before access to a resource is granted, a determination may be performed to check whether the user is within a locality. A locality may be an area. The locality may be defined by physical (e.g., walls) and/or intangible boundaries (e.g., a geofence).

Determining whether the user is within the locality may be carried out by using one or more devices (e.g., a user device of the user, a camera, a biometric sensor, a beacon) within the locality to check if the user is within the locality. One or more components (e.g., sensors) of each device and multiple devices can be used to check if the user is within the locality. Using one or more components of one or more devices may increase the likelihood of correctly determining the user is within the locality. Information from the one or more components of the one or more devices may be referred to as locality attributes and can be included in locality credentials. Locality credentials can be processed by a locality verification system to determine if the locality credential is trusted.

A resident device may include the locality verification system. Upon the locality verification system determining the locality credential is trusted, the user associated with the locality credential can be permitted access to a resource. In certain embodiments, permitting access to the resource enables the user to control an environment device (e.g., a smart lock of a door). The resident device may be communicatively coupled with the resident device and be able to control the environment device via the communicative coupling with the resident device. In a similar manner as described above, certain techniques described herein can enable a user and/or a user device to obtain access to a resource based on where the user and/or user device is.

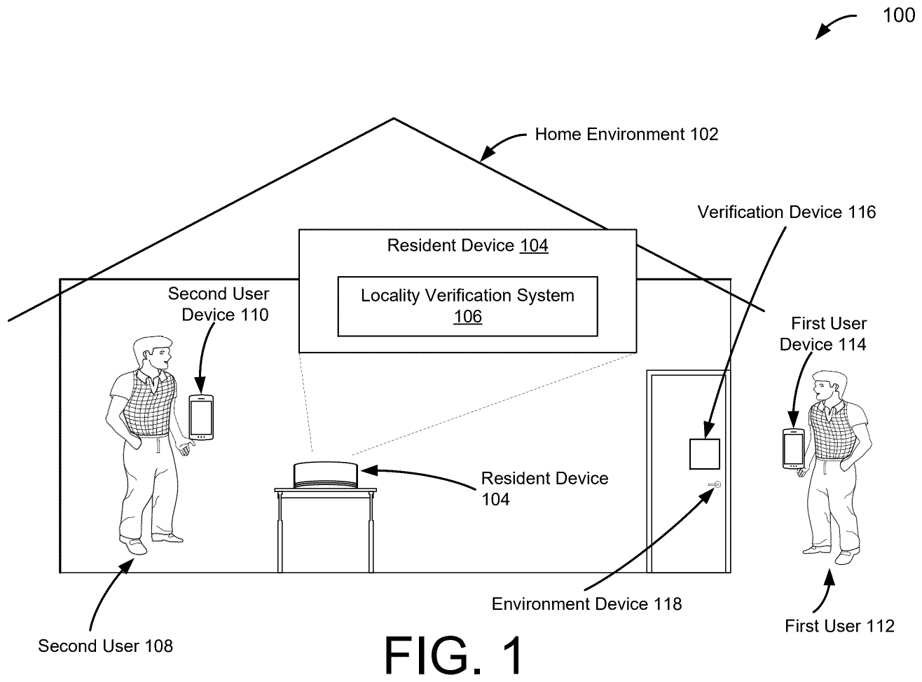

FIG. 1 is a simplified block diagram of an example system 100, according to some embodiments. The system 100 includes a home environment 102, a first user 112 with a first user device 114, a second user 108 with a second user device 110, a resident device 104, an environment device 118, and a verification device 116.

In system 100, the depicted example environment is the home environment 102. The home environment 102 may include one or more people who have some affiliation (e.g., family members, roommates, friends, business, etc.). In this example, the first user 112 and the second user 108 may represent affiliated users, and may respectively be associated with the first user device 114 and the second user device 110. Also, within the home environment 102 there may be the resident device 104 (e.g., a tablet, a smart home controller, a smart digital media player, a home automation device (e.g., that is part of a home automation system), or the like). The resident device 104 may be communicatively coupled with the verification device 116 (e.g., a camera) and/or the environment device 118 (e.g., a smart accessory (e.g., a television, an audio device, a light fixture, a garage door opener, an architectural covering, a camera, a lock, an alarm system, or an air conditioning unit). The resident device 104 may receive a request to access the home environment 102 from the first user device 114. The resident device 104 may receive a first locality credential from the verification device 116 that indicates a locality of the first user 112 and/or first user device 114 after the verification device 116 obtained information about the first user 112 and/or the first user device 114. The resident device 104 may trust the verification device 116 and therefore, control the environment device 118 to unlock and permit the first user 112 to access a resource such as the home by causing the environment device 118 to unlock the door.

In certain embodiments, the resident device 104 may receive a locality credential from the first user device 114 and/or from one or more verification devices 116 to determine the locality of the first user device 114 and/or the first user 112 is trusted and the locality indicates the first user 112 and/or first user device 114 is within the locality associated with the home environment 102 before the resident device 104 enables control of and/or controls one or more environment devices 118 (e.g., to unlock, to permit WIFI access, to open a door, to turn on lights, to turn off an alarm system, etc.).

In some embodiments, a user device (e.g., the first user device 114, the second user device 110) may be any suitable computing device. In a non-limiting example, the user device may be a mobile phone, a tablet, a PC, a laptop, etc. The user device may be capable of communicating (e.g., using a wired connection, using a wireless connection, over a network connection) with the resident device 104, the verification device 116, and/or the environment device 118. The user device may include one or more components that can be used to generate a second locality credential for proving the locality of the user device to the locality verification system 106 of the resident device 104.

The locality of the user device (e.g., the first user device 114) and/or user of the user device (e.g., the first user 112) can be proven using the second locality credential including one or more locality credential attributes generated by one or more components of the user device. For example, the user device (e.g., the first user device 114) may include a camera (e.g., built into the user device or otherwise connected (e.g., via a cable or wireless connection)), a speaker, a microphone, a display, an accelerometer, a gyroscope, a magnetometer, a barometer, a biometric sensor (e.g., a fingerprint scanner), a temperature sensor, a Bluetooth (e.g., Bluetooth Low Energy) transmitter, a Bluetooth receiver, a near field communication (NFC) antenna, a touchscreen, a radio antenna (e.g., for Wi-Fi communications, for out of band communication), a global positioning system (GPS) receiver. One of ordinary skill in the art with the benefit of the present disclosure would recognize other components that may be included in the user device.

The verification device 116 may be any suitable computing device. In a non-limiting example, the verification device 116 may be a mobile phone, a tablet, a PC, a laptop, a television, a lock, an appliance, a speaker, etc. The verification device 116 may be capable of communicating (e.g., using a wired connection, using a wireless connection, over a network connection) with the resident device 104, the first user device 114, and/or the environment device 118. The verification device 116 may include one or more components that can be used to generate the first locality credential including one or more locality credential attributes for proving the locality of the first user device 114 and/or the first user 112 to the resident device 104.

The verification device 116 may include one or more components such as a camera, a display, a touchscreen, a biometric sensor (e.g., fingerprint scanner), a speaker, a microphone, a motion sensor, a barometer, a temperature sensor, a Bluetooth (e.g., Bluetooth Low Energy) transmitter, a Bluetooth receiver, a near field communication (NFC) antenna, a radio antenna (e.g., for Wi-Fi communications, for out of band communications), a global positioning system (GPS) receiver, etc. Locality of the user device (e.g., the first user device 114) and/or user (e.g., the first user 112) can be proven using the first locality credential including one or more locality credential attributes generated by one or more components of the verification device 116.

In some embodiments, the resident device 104 may be any suitable computing device that resides in a particular environment and is configured to control (e.g., provide control instructions) one or more operations and/or environment devices (e.g., environment device 118, accessories in the home environment (e.g., the home environment 102)). In some non-limiting examples, a resident device 104 may be a smart speaker, a smart TV device, a tablet device, a smart digital media player (e.g., configured to provide streaming media to a TV), etc. In the example of system 100, resident device 104 may correspond to a smart speaker device. Upon the resident device 104 determining a locality credential received (e.g., from the first user device 114 and/or from the verification device 116) is trusted, the resident device 104 may communicate with one or more environment devices (e.g., using a wired connection, using a wireless connection, over a network connection). The resident device 104 may control the one or more environment devices after determining the locality credential is trusted. The resident device 104 may control the one or more environment devices based on instructions from the first user 112 (e.g., input by the first user 112 via a user interface of the first user device 114 or environment device 118) and/or the first user device 114.

The locality credential may be trusted based on one or more locality credential attributes analyzed by a locality verification system 106. A locality credential attribute may be information that can be used to identify a locality (e.g., an image, a sound file, an atmospheric pressure reading, a temperature reading, a GPS location, etc.).

For example, the locality credential asserting the first user 112 and/or the first user device 114 is within a locality may be determined to be trusted by the locality verification system 106 if it is from the first user device 114 and includes one or more locality credential attributes indicating the first user device 114 is within the locality (e.g., trust based on a single locality credential). The locality credential may be determined to be trusted by the locality verification system 106 if it is from the verification device 116 and includes one or more locality credential attributes indicating the first user device 114 and/or the first user 112 is within the locality. For example, the verification device 116 may be a camera device in the locality and therefore if the verification device 116 captures an image of the first user 112, the first user 112 is proven to be in the locality (e.g., trust based on a single locality credential) via the trust established by the locality credential from the verification device 116. The locality credential may be determined to be trusted by the locality verification system 106 if it is from the verification device 116 and includes one or more locality credential attributes indicating the first user device 114 and/or the first user 112 is within the locality and a second locality credential from the first user device 114 includes one or more locality credential attributes indicating the first user device 114 is within the same locality (e.g., trust based on two locality credentials).

The locality verification system 106 may include one or more resource control settings (e.g., a profile management system). The resource control settings may be configured by an owner of the resident device 104, a network administrator, the second user 108, etc. The resource control settings may define which resources can be accessed after a locality credential is trusted. The resource control settings may define which users and/or user devices can control which resources (e.g., environment devices). The resource control settings may define which days and times a locality credential can be used to access a resource. The resource control settings may define which days and times a specific user and/or user device corresponding to a locality credential can be trusted. The resource control settings may define how long a locality credential can be trusted. The resource control settings may define when to send notifications and what information is included in notifications sent responsive to a locality credential being trusted, a user device being detected in a locality, a user being detected in a locality, etc.

In certain embodiments, after determining the locality credential is trusted, the resident device 104 may present and/or transmit a notification. For example, the notification may be presented by the resident device 104 using a display and/or a sound. As an example, the resident device 104 may transmit a notification to the second user device 110 (e.g., on the same network as the resident device 104, associated with the resident device 104 (e.g., the owner)) that informs the second user 108 of the second user device 110 that the first user device 114 and/or the first user 112 have proven their locality to the resident device 104. The resident device 104 may transmit a notification to the second user device 110 that can inform the second user 108 of the second user device 110 that the first user device 114 and/or the first user 112 have been granted access to a resource (e.g., the home environment 102, control of one or more devices communicatively coupled with the resident device 104).

It should be understood that notifications may be provided by a resident device 104 using any suitable channel and/or method, depending, for example, on the type of resident device, a type of user device, the surrounding environment, etc. For example, consider another embodiment, where the resident device 104 may correspond to a smart TV device (e.g., a digital media player that is connected to a TV). The smart TV device may be equipped to present a graphical user interface (GUI) on the TV, which may include a Picture-in-Picture (PIP) presentation. In this example, the resident device may provide a notification in the form of an audiovisual (AV) feed. For example, the resident device may display a video feed (e.g., received from a camera of the verification device) in the inset window of the TV.

In certain embodiments, the resident device 104 may be configured to provide notifications based at least in part on the person recognized. For example, in one embodiment, resident device 104 may receive a request from the second user device 110 (e.g., the owner of the resident device) to only receive notifications when a person is detected who is not on an allow list or is on a block list. This setting may be used for example, when the second user 108 only wants to be notified when non-contacts approach the home environment 102, but not when relatives are approaching the home environment 102. In another embodiment, resident device 104 may receive a request from the second user device 110 to only receive notifications when the first user device 114 is detected within the locality and is a contact associated with the second user device 110. In another embodiment, resident device 104 may receive a request from the second user device 110 to only receive notifications when the resident device 104 determines a locality credential is trusted.

In another embodiment, the resident device 104 may be configured to provide a notification when any locality credential is received. It should be understood that the above-described settings are only representative, and any suitable types of settings may be used to configure the resident device 104. In some cases, a particular setting may increase the number of notifications provided by a resident device 104 (e.g., configuring the resident device 104 to notify a user whenever any person is detected). In some cases, a particular setting may result in a decrease in the number of notifications provided by a resident device 104 (e.g., configuring the resident device 104 to only provide notifications if a locality credential is determined to be trusted and it is a certain time of day). In some embodiments, a notification may contain an identification of the user device detected, the user detected, when the user device was detected, when the user was detected, what devices the user device has controlled, etc.

Although system 100 depicts a home environment 102 context in which the system detects a person within the same locality of the front door of the home, it should be understood that embodiments of the present disclosure may be performed in any suitable context. For example, instead of the first user 112 and/or the first user device 114 within a locality that includes the front door outside the home causing one or more locality credentials to be transmitted to the resident device 104, the first user 112 and/or the first user device 114 may be in a particular locality inside the home. In this example, the system may alert a user within another locality within and/or outside of the home (e.g., the homeowner) that another person (e.g., a dog walker, a caretaker) has entered a particular locality within the home. Embodiments may also be performed in a non-home environment context. For example, a business office may detect when certain visitors have arrived, grant resource access (e.g., network access, physical access) to certain visitors, or a government office may detect when there may be unauthorized access to a particular locality (e.g., area, location).

In certain embodiments, the resident device 104 includes a verification device 116 and/or performs one or more functions of the verification device 116. In certain embodiments, the environment device 118 includes a verification device 116 and/or performs one or more functions of the verification device 116.

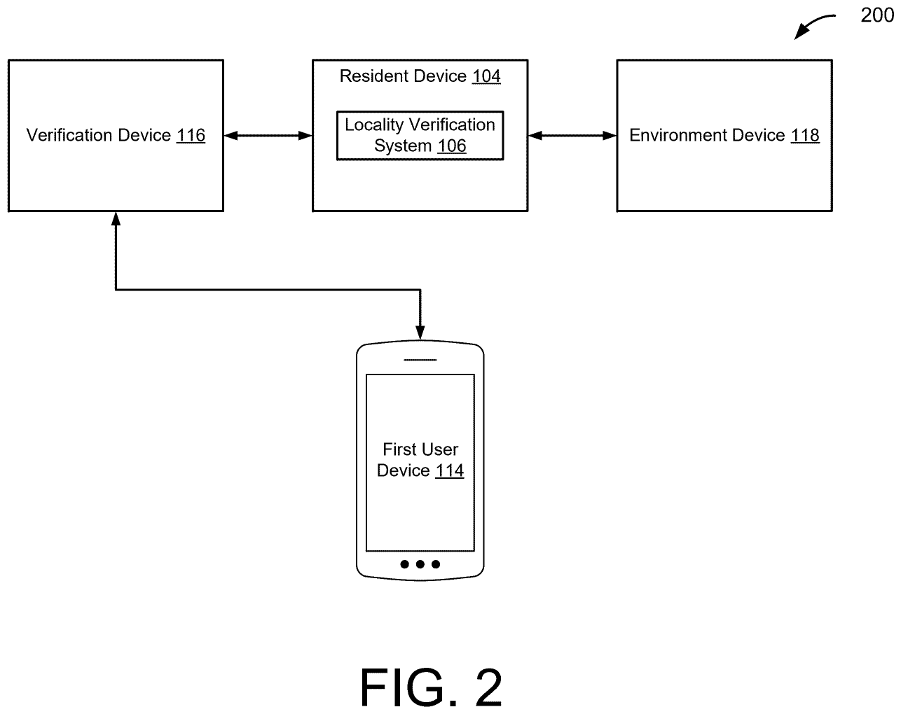

FIG. 2 is a simplified block diagram of a system 200 illustrating at least some example techniques for proving locality of a user device (e.g., the first user device 114), according to some embodiments. The system 200 includes the first user device 114, the verification device 116, the resident device 104, and the environment device 118. Each of the system components illustrated in system 200 may perform functions as described above. System 200 is an example of how the verification device 116 may cause one or more locality credentials to be transmitted to the resident device 104 for control of a resource, such as the environment device 118. The verification device 116 may transmit a locality credential generated by verification device 116 and/or a second locality credential generated by the first user device 114 to the resident device 104.

In certain embodiments, the verification device 116 generates the first locality credential to be transmitted to the resident device 104. The first locality credential may be generated by the verification device 116 based on one or more components the verification device 116 includes. The verification device 116 may include at least one of: a camera, a display, a touchscreen, a biometric sensor (e.g., fingerprint scanner), a speaker, a microphone, a motion sensor, a barometer, a temperature sensor, a Bluetooth (e.g., Bluetooth Low Energy) transmitter, a Bluetooth receiver, a near field communication (NFC) antenna, a radio antenna (e.g., for Wi-Fi communications, for out of band communications), a global positioning system (GPS) receiver, etc.

The one or more components of the verification device 116 may be used to obtain locality attributes. Locality attributes may include information that can be used to identify a locality. In certain embodiments, the locality attributes may include any information obtained by the verification device 116. For example, the locality attributes may include at least one of: an image, a sound file, an atmospheric pressure reading, a temperature reading, a GPS location, a coordinate, a device identifier (e.g., a globally unique device identifier), a user identifier (e.g., a username), a locality credential identifier, a password, a challenge response, information obtained from a device in a locality the resident device can manage, a timestamp (e.g., when the locality attribute was generated), an indication of a type of communication (e.g., an indication that the device identifier was received via NFC), etc.

The resident device 104 may receive one or more locality credentials from one or more verification devices 116. Each locality credential may include one or more locality attributes, locality credential identifiers, a time to live, and/or a timestamp of when the locality credential was generated. The locality credentials can be used by the locality verification system 106 of the resident device 104 to determine if the locality credential is trusted. If trusted, the resident device 104 may control one or more devices (e.g., one or more environment devices 118) to enable a user to access a resource.

In certain embodiments, if trusted, the resident device 104 may transmit a notification to one or more devices (e.g., the verification device 116, the environment device 118, the first user device 114, another user device communicatively coupled with the resident device 104, etc.) communicatively coupled with the resident device 104. The notification may be used to present at least one of: information that a trusted access credential was received by the locality verification system 106, the device (e.g., the verification device 116) the locality credential was received from, the time the locality credential was received, the device (e.g., the verification device 116) that generated the locality credential, the first user device 114 that has been granted access to a resource as a result of the trusted locality credential, a user that has been granted access to a resource as a result of the trusted locality credential. In certain embodiments, if the locality credential is trusted, the resident device 104 may communicatively couple with the first user device 114 (e.g., establish a wireless connection with the first user device 114).

In certain embodiments, if the locality credential received by the locality verification system 106 fails to be determined as trusted, a notification may be transmitted to one or more devices that present information relating to the failure to trust the locality credential. In certain embodiments, if the locality credential received by the locality verification system 106 fails to be determined as trusted, one or more environment devices may be controlled (e.g., to lock a door, to close a door, to sound an alarm, to emit a warning signal, to flash lights, etc.).

Some illustrative examples of locality attributes and how they may be processed (e.g., by the locality verification system 106) are detailed below. An example of a locality attribute may be an image of a user taken by the verification device 116. The image of the user may be processed by the resident device 104 to determine if the image of the user includes a user that is allowed to access a resource managed by the resident device 104. If so, the resident device 104 may control one or more devices (e.g., the environment device 118) to enable the user to access a resource.

An example where the locality verification system 106 relies on multiple locality attributes may be a combination of a device identifier and a type of wireless communication used by the verification device 116. The device identifier of the nearby first user device 114 may be received by the verification device 116 from the nearby first user device 114 using short-range wireless communication (e.g., Bluetooth, NFC, etc.). Due to the short-range nature of the communication, the fact that the device identifier of the first user device 114 was communicated to the verification device 116 can be included in a locality credential including the locality attributes that represent the type of wireless communication used and the first user device identifier. The verification device 116 may transmit the locality credential with the locality attributes to the resident device to verify with the locality verification system 106. If the first user device identifier and/or a user associated with the first user device identifier is on an allow list and/or not on a block list, the locality verification system 106 may determine the locality credential received from the verification device 116 is trusted. If trusted, the resident device 104 may control one or more devices (e.g., the environment device 118) to enable the user of the first user device to access a resource.

In certain embodiments, in addition to or as an alternative to the verification device 116 generating a first locality credential, the verification device 116 may receive a second locality credential from the first user device 114. The first user device 114 may include any of the components that a verification device 116 may include. For example, the first user device 114 may include at least one of: a camera, a display, a touchscreen, a biometric sensor (e.g., fingerprint scanner), a speaker, a microphone, a motion sensor, a barometer, a temperature sensor, a Bluetooth (e.g., Bluetooth Low Energy) transmitter, a Bluetooth receiver, a near field communication (NFC) antenna, a radio antenna (e.g., for Wi-Fi communications), a global positioning system (GPS) receiver, etc.

The second locality credential received from the first user device 114 may include one or more locality attributes. In certain embodiments, the locality attributes may include any information obtained by the first user device. For example, the locality attributes may include at least one of: an image, a sound file, an atmospheric pressure reading, a temperature reading, a GPS location, a device identifier (e.g., a globally unique device identifier), a user identifier (e.g., a username), a password, a challenge response, information obtained from a device in a locality the resident device can manage (e.g., a beacon signal, network data), etc.

In certain embodiments, the verification device 116 may transmit the second locality credential received from the first user device 114 to the resident device 104 to be processed by the locality verification system 106. The locality verification system 106 may process the second locality credential generated by the first user device 114 and transmitted to the resident device 104 via the verification device 116 in a similar manner as a locality credential generated by the verification device 116 may be processed, as described above.

In certain embodiments, the locality verification system 106 may assign a score to locality attributes and/or a locality credential. Each locality attribute may be assigned a score based at least on how (e.g., the sensor used to obtain the locality attribute) the attribute was obtained, when the attribute was obtained. Each locality credential may be assigned a score based at least on the device that generated the locality credential, how many locality attributes are included in the locality credential, the score of the locality attributes included in the locality credential, and/or when the locality credential was generated. The locality verification system 106 may determine if the score assigned to the locality credential is above a threshold score to determine whether the locality credential is to be trusted. By scoring locality credentials and/or locality attributes, certain devices (e.g., the first user device 114, the verification device 116) and/or locality attributes can be trusted more than others.

In certain embodiments, different resources associated with a first locality may require a higher score threshold to be satisfied before access to resources associated with the first locality is permitted. In certain embodiments, different users may need to satisfy a higher score threshold before access to a resource associated with the locality is permitted.

In certain embodiments, the first user device 114 may generate a first locality credential associated with the first user device 114 and/or the user of the first user device 114 and transmit the first locality credential to the verification device 116. In certain embodiments, the verification device 116 may generate a second locality credential associated with the first user device 114 and/or the user of the first user device 114. The verification device 116 may transmit the first locality credential and/or the second locality credential to the resident device 104 to be input to the locality verification system 106 to determine if the first locality credential and/or second locality credential can be trusted. In certain embodiments, access is permitted to a resource controlled by the resident device 104 when one of the first locality credential and the second locality credential are trusted. In certain embodiments, access is permitted to a resource controlled by the resident device when both of the first locality credential and the second locality credential are trusted.

In certain embodiments, access is permitted to a resource controlled by the resident device 104 when the first locality credential is sufficiently similar to the second locality credential. For example, the first locality credential may include first locality attributes that include a microphone reading, an atmospheric pressure reading, and a GPS location from the first user device 114 and the second locality credential may include second locality attributes that include a microphone reading, an atmospheric pressure reading, and a GPS location from the verification device 116. The locality verification system 106 may determine that the sounds represented by the microphone reading, the atmospheric pressure represented by the atmospheric pressure reading, and the GPS location included in each of the first locality credential and the second locality credential are similar enough (e.g., within a predefined range) such that the locality verification system 106 can be confident the first user device 114 and the verification device 116 were in the same locality when the information to generate each of the credentials was obtained. The locality verification system 106 may cause the resident device 104 to permit the first user device 114 and/or the first user of the first user device 114 access to a resource because the locality verification system 106 trusts the first user device 114 is within the same locality of the verification device 116 and the verification device 116 is expected to be in the locality managed by the resident device 104.

In certain embodiments, the verification device 116 includes a second locality verification system, in addition to the locality verification system 106 of the resident device 104 or as an alternative to the locality verification system 106 of the resident device 104. In an embodiment where the verification device 116 includes the second locality verification system, upon determining one or more locality credentials are trusted, the verification device 116 may transmit an indication of the trust to the resident device 104 to cause the resident device 104 to permit the user of the first user device 114 and/or the first user device 114 access to one or more resources. In certain embodiments, the verification device 116 may transmit information (e.g., network access information, a device identifier) to the resident device 104 and/or the first user device 114 that enables the resident device 104 to establish a communicative coupling with the first user device 114.

In certain embodiments, the processing that the locality verification system 106 performs may be partially or completely performed by the verification device 116 and/or a server (e.g., a remote server). In embodiments, where the resident device 104 performs the locality verification system 106 functionality, the information used to determine if a locality credential is trusted can be stored in fewer devices and may improve security and reduce network traffic compared to determining whether locality credentials are trusted at one or more verification devices. In embodiments, where one or more verification devices perform the locality verification system 106 functionality, the processing performed to determine if a locality credential is trusted can be distributed among one or more devices and may alleviate the computational resources used by the resident device 104 compared to determining whether locality credentials are trusted using the resident device 104. Such an embodiment can be beneficial when resident device 104 processing capabilities are limited and/or when many user devices and/or users are causing locality credentials to be generated.

Next, an illustrative example of how the components of the system 200 may be configured to operate is described. In an example, the first user device 114 may be a mobile phone of a first user and may be capable of transmitting an NFC signal. The verification device 116 may be an NFC reader integrated into a smart lock of a door. The environment device 118 may include the smart lock of the door. Thus, in this example, the verification device 116 and the environment device 118 may be the same device. The resident device 104 may be a speaker inside of a house on one side of the door. The resident device 104 may be configured to be communicatively coupled with the verification device 116 (e.g., using a Wi-Fi network connection). The resident device 104 may trust that the verification device 116 is within a locality managed by the resident device 104. The resident device 104 may trust the verification device 116 because the verification device 116 was configured to be trusted, the verification device 116 is in a fixed location, and/or the verification device 116 is on the same local network as the resident device 104. A second user who manages the resident device 104, is the owner of the home, is the owner of the resident device 104, is the owner of the environment device 118, and/or manages resource access permissions may configure the first user device 114 to be a user device on an allow list.

The first user of the first user device 114 may desire to have the environment device 118 cause the door to be unlocked. When the first user device 114 is brought within NFC communication range of the verification device 116, the verification device 116 may receive information that identifies the first user device 114. The verification device 116 may transmit a locality credential to the resident device 10 that includes locality attributes. The locality attributes may include an indication that NFC was used and the NFC was performed between the verification device 116 and the first user device 114. The locality verification system 106 of the resident device 104 may receive the locality credential and determine whether the locality credential is trusted. The locality verification system 106 may determine the locality credential is trusted because the first user device identifier is on an allow list, short-range communication was used (e.g., NFC) between the verification device 116 and the first user device 114, and the locality of the verification device 116 is known and/or trusted.

If the locality verification system 106 determines the locality credential is trusted, the resident device 104 may communicate with the environment device 118 (e.g., using a network connection, using Bluetooth, using Wi-Fi, etc.) and cause the environment device 118 to be controlled. The environment device 118 may be controlled to unlock responsive to the communication received from the resident device 104.

In the example, after the locality verification system 106 determines the locality credential is trusted, the resident device 104 may communicate with the verification device 116 and cause the verification device 116 to transmit information to the first user device 114. The information may include a network credential so the first user device 114 can access the network and/or may include a credential that enables the first user device 114 to establish a wireless communicative coupling with the resident device 104 (e.g., using Bluetooth, using Wi-Fi).

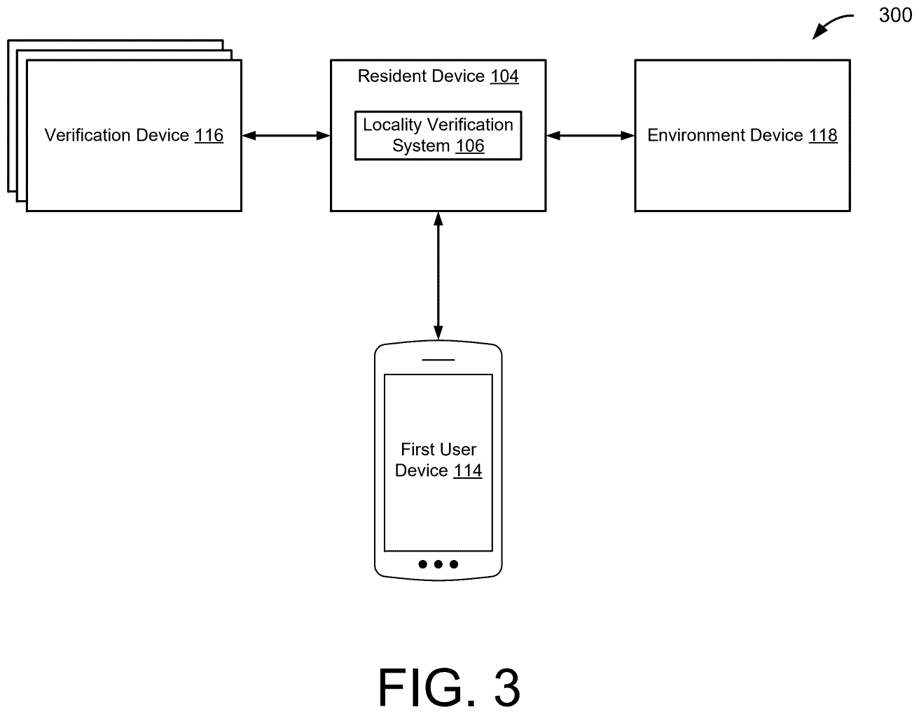

FIG. 3 is a simplified block diagram of a system 300 illustrating at least some example techniques for proving locality of a user device (e.g., the first user device 114), according to some embodiments. The system 300 includes the first user device 114, the verification device 116, any number of other verification devices, the resident device 104, and the environment device 118. Each of the system components illustrated in system 300 may perform functions as described above. The system 300 is an example of how the verification device 116 and/or the first user device 114 may cause one or more locality credentials to be transmitted to the resident device 104 for control of a resource, such as the environment device 118. The verification device 116 may transmit a first locality credential generated by verification device to the resident device 104. The first user device 114 may transmit a second locality credential generated by the first user device 114 to the resident device 104.

The verification device 116 and/or any number of other verification devices may generate a locality credential to be transmitted to the resident device 104 by the verification device 116. As described above, the first locality credential may be generated by the verification device 116 based on one or more components the verification device 116 includes. As described above, the one or more components of the verification device 116 may be used to obtain locality attributes to include in the locality credential.

The first user device 114 may generate the second locality credential to be transmitted to the resident device 104 by the first user device 114. As described above, the second locality credential may be generated by the first user device 114 based on one or more components the first user device 114 includes. As described above, the one or more components of the first user device 114 may be used to obtain second locality attributes to include in the second locality credential. The resident device 104 may receive the second locality credential from the first user device 114 and the first locality credential from the verification device 116.

In certain embodiments, the locality verification system 106 compares the first locality credential to the second locality credential to determine whether both of the locality credentials are trusted. In certain embodiments, a locality credential generated by the verification device 116 is always trusted since the verification device may be on the same network as the environment device 118 and/or the resident device 104. In certain embodiments, the verification device 116 locality credential is always trusted since the verification device 116 may be at a fixed and trusted location.

In certain embodiments, determining whether both of the locality credentials are trusted may include determining if the second locality credential includes locality attributes that represent the same locality of the locality attributes of the first locality credential. For example, the verification device 116 may measure atmospheric pressure and light intensity and the first user device 114 may also measure atmospheric pressure and light intensity. If the verification device 116 produces similar atmospheric pressure and light intensity from its measurements as the atmospheric pressure and light intensity measurements of the first user device 114, the second locality credential may be determined as trusted by the locality verification system 106. The example at least illustrates that locality attributes of a similar type may be compared to determine if the attributes are within a defined similarity threshold.

In an example, the verification device 116 may measure atmospheric pressure and light intensity and the first user device 114 may measure atmospheric pressure, light intensity, and determine GPS coordinates of the first user device 114. If the verification device 116 produces similar atmospheric pressure and light intensity from its measurements as the atmospheric pressure and light intensity measurements of the first user device, and the GPS coordinates are within the locality managed by the resident device 104, the second locality credential may be determined as trusted by the locality verification system 106. The example at least illustrates that a first set of one or more locality attributes from a first device and a second set of one or more locality attributes from a second device may be used by the locality verification system 106 to determine whether one or both of the locality credentials are trusted.

In certain embodiments, the locality verification system 106 may permit control of the environment device 118 even if only one of the first locality credential and the second locality credential are trusted. For example, the first locality credential received from the verification device 116 may have a trust score associated with it. The trust score may be based on the number of locality attributes the locality credential includes, which locality attributes are included, the verification device that generated the locality credential, when the locality credential was generated, etc. The locality verification system 106 may determine whether one or more locality credentials are trusted based on the summed trust score of each of the locality credentials. Thus, even if one locality credential on its own would not be determined by the locality verification system 106 as trusted, the locality verification system 106 may still cause the environment device 118 to be controlled based on the trust of one or more other locality credentials (e.g., from one or more verification devices). Such embodiments can be useful because the first user device 114 may have components that are not functioning properly, may have had communication interrupted with the resident device 104, may not be running a trusted software version, etc., but the first user device 114 and/or the first user can still be provided with access to a resource based on the first locality credential being trusted.

In certain embodiments, the resident device 104 may receive locality credentials from more than one verification device. Multiple verification devices can be used to add redundancy and/or additional trust that the first user device 114 or first user is within a locality. The verification devices may be the same type of device or different device as other verification devices. For example, a first verification device may be a camera and a second verification device may be an NFC reader. The locality verification system 106 may determine whether the locality credentials respectively received from the first verification device and the second verification device are trusted before controlling the environment device 118. The resident device 104 may additionally receive the second locality credential from the first user device 114. The locality verification system 106 may use any combination of locality credentials received from any combination of devices (e.g., verification devices and/or user devices) to determine whether to control the environment device 118.

In certain embodiments, the resident device 104 may receive the second locality credential from the first user device 114 and not receive a locality credential from the verification device 116. In such embodiments, the locality verification system 106 may determine whether to trust the credential and control the environment device 118 based on the single locality credential received from the first user device 114.

In certain embodiments, the locality verification system 106 uses more than one locality credential received from the same device (e.g., the first user device 114) to determine whether to control the environment device 118 (e.g., permit access to a resource). Such embodiments may provide for additional assurance that the first user device 114 is within a locality managed by the resident device 104.

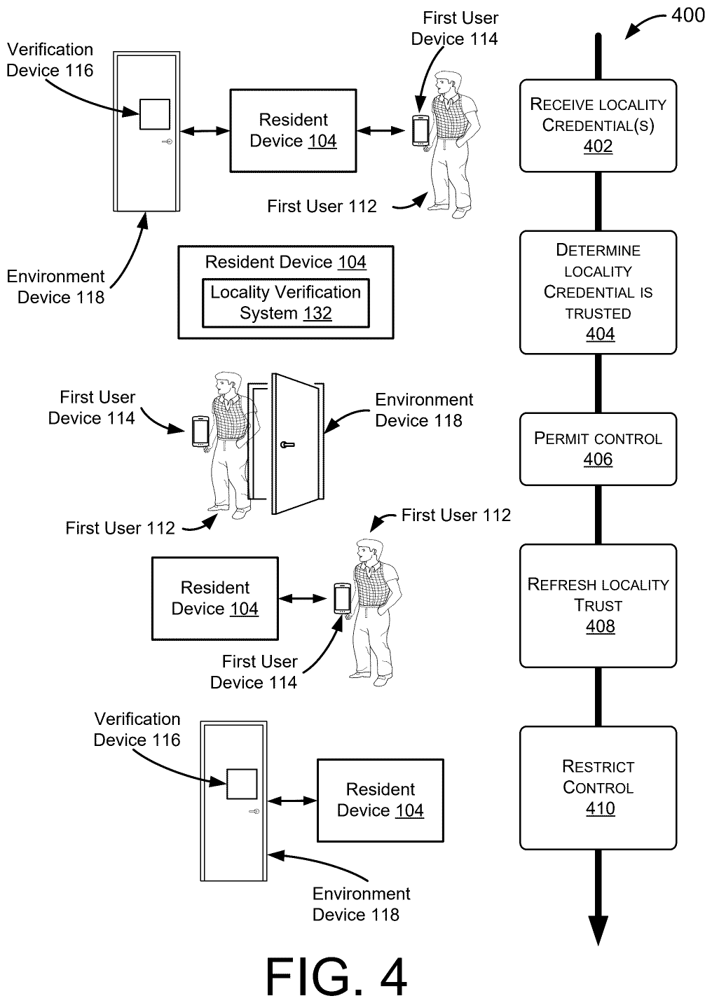

FIG. 4 is a simplified block diagram 400 illustrating access control management based on proof of locality of a user device (e.g., the first user device 114), according to some embodiments.

At 402, a resident device 104 may generate one or more locality credentials. A locality credential may be received from a first user device 114 via a communicative coupling with the resident device 104. A locality credential may be received from a verification device 116 (e.g., an NFC scanner) communicatively coupled with the resident device 104. In certain embodiments, a locality credential is received from more than one verification device (e.g., a NFC scanner and a camera) and/or from more than one user device (e.g., a smartphone and a smartwatch). The locality credential may include one or more locality attributes that help prove the locality the first user device 114 and/or user is within. Further details regarding locality credentials, locality attributes, and the devices have been described above.

At 404, a locality verification system 106 may determine whether a locality credential received is trusted. The locality verification system 106 in the block diagram 400 is local to the resident device 104. In certain embodiments, the locality verification system 106 is local to one or more devices (e.g., the resident device 104, a verification device 116, and/or a server). In certain embodiments, the locality verification system 106 is included in a server (e.g., a remote server). The server may be communicatively coupled with the resident device 104 and the network the verification device 116 and/or the resident device 104 is included in.

The locality verification system 106 may use one or more locality attributes of one or more locality credentials to determine if a locality credential is trusted and to cause access to a resource to be permitted (e.g., the environment device 118 to be controlled). The locality verification system 106 may use scores associated with locality credentials and/or locality attributes to determine if a locality credential is trusted and to cause access to a resource to be permitted.

In the block diagram 400, if the locality verification system 106 determines a locality credential associated with the first user 112 and/or first user device 114 is trusted, the resident device 104 may cause one or more devices (e.g., environment devices 118 to be controlled). The environment device 118 may permit access to one or more resources to the first user device 114 and/or the first user 112.

At 406, the resource access may be associated with a time to live. In other words, a locality credential associated with the first user 112 and/or the first user device 114 may enable the first user 112 and/or the first user device 114 to access a resource for a period of time before either the access is restricted or a new locality credential is needed to refresh the resource access permission. In certain embodiments, the time to live may be predefined and/or based on the first user 112, the first user device 114, the device that generated the locality credential (e.g., the verification device 116), the number of locality attributes included in the locality credential, the locality attributes included in the locality credential, the score of the locality credential, the score of the locality attributes, the resource access was permitted to, how many times the first user 112 and/or the first user device 114 have been granted access to a resource (e.g., the resource), if the first user 112 and/or first user device 114 is on an allow list, the time of day the locality credential was generated, etc.

At 408, the time to live may be extended or refreshed. The time to live may be extended or refreshed when the first user 112 and/or first user device 114 causes another locality credential to be generated and transmitted to the locality verification system (e.g., by a verification device 116, by the first user device 114).

At 410, access to the resource may be restricted. The access to the resource may be restricted such that another user and/or user device needs to cause a locality credential to be transmitted to the locality verification system 106 to be determined if it trustworthy before access to a resource is permitted. For example, the first user 112 may cause a locality credential to be transmitted to the locality verification system 106 and the resident device 104 unlocks a door for the first user 112 to enter through, and then locks the door after a set amount of time so a second user cannot enter through the door before first causing a locality credential to be transmitted to the locality verification system 106.

In another example, the first user 112 may cause a locality credential to be transmitted to the locality verification system 106 and the locality verification system 106 enables the user to access a resource (e.g., control an environment device (e.g., a smart thermostat)). The first user 112 may cause the access to be refreshed periodically (e.g., by causing the first user device 114 and/or a verification device 116 to generate and transmit a locality credential to the locality verification system 106 that is determined to be trusted) until the first user 112 leaves the locality and therefore the first user device 114 and/or a verification device 116 cannot generate and transmit a locality credential to the locality verification system 106 associated with first user 112 that can be determined to be trusted (e.g., because the first user 112 is no longer within the locality).

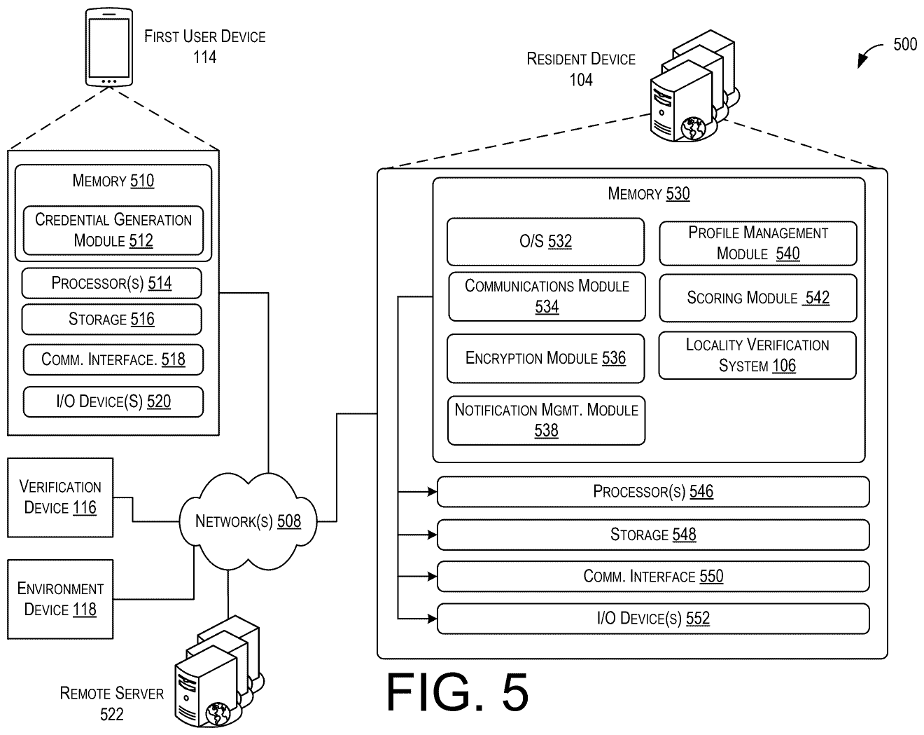

FIG. 5 is a simplified block diagram illustrating an example architecture of a system 500 used to manage resource access based on proof of locality of a user device, according to some embodiments.

The system 500 includes a first user device 114, a verification device 116, an environment device 118, a resident device 104, a network 508, and a remote server 522. The first user device 114, the verification device 116, the environment device 118, and the resident device 104, may be similar to any of the user devices, verification devices, environment devices, and/or resident devices described herein. The remote server 522 may correspond to one or more server computers (e.g., a server cluster) of a cloud computing platform, as described herein.

The network 508 may include any suitable communication path or channel such as, for instance, a wire or cable, fiber optics, a telephone line, a cellular link, a radio frequency (RF) link, a WAN or LAN network, the Internet, or any other suitable medium. The network 508 may include any one or a combination of many different types of networks, such as cable networks, the Internet, wireless networks, cellular networks, and other private and/or public networks. The network may use infrared, ultra-wideband (UWB), Apple Wireless Direct Link (AWDL), Bluetooth (BT), Bluetooth low energy (BTLE), Wi-Fi, and/or radio communication techniques.

Turning to each element in further detail, the first user device 114 may be any suitable computing device (e.g., a mobile phone, tablet, personal computer (PC), smart glasses, a smart watch, etc.). The user device 502 has at least one memory 510, one or more processing units (or processor(s)) 514, a storage unit 516, a communications interface 518, and an input/output (I/O) device(s) 520.

The processor(s) 514 may be implemented as appropriate in hardware, computer-executable instructions, firmware or combinations thereof. Computer-executable instruction or firmware implementations of the processor(s) 514 may include computer-executable or machine executable instructions written in any suitable programming language to perform the various functions described.

The memory 510 may store program instructions that are loadable and executable on the processor(s) 514, as well as data generated during the execution of these programs. Depending on the configuration and type of user device 502, the memory 510 may be volatile (such as random access memory (RAM)) and/or non-volatile (such as read-only memory (ROM), flash memory, etc.). In some implementations, the memory 510 may include multiple different types of memory, such as static random access memory (SRAM), dynamic random access memory (DRAM) or ROM. The first user device 114 may also include additional storage 516, such as either removable storage or non-removable storage including, but not limited to, magnetic storage, optical disks, and/or tape storage. The disk drives and their associated computer-readable media may provide non-volatile storage of computer-readable instructions, data structures, program modules, and other data for the computing devices. In some embodiments, the storage 516 may be utilized to store a photo library containing one or more images on the first user device 114.

The first user device 114 may also contain the communications interface 518 that allows the user device 502 to communicate with the verification device, the resident device, another computing device or server, user terminals, and/or other devices on the network(s) 508. The first user device 114 may also include I/O device(s) 520, such as for enabling connection with a keyboard, a mouse, a pen, a voice input device, a touch input device, a display, speakers, a printer, and/or other components the first user device 114 may include.

The communications interface 518 and/or the I/O device(s) 520 may include at least one of: a camera, a display, a touchscreen, a biometric sensor (e.g., fingerprint scanner), a speaker, a microphone, a motion sensor, a barometer, a temperature sensor, a Bluetooth (e.g., Bluetooth Low Energy) transmitter, a Bluetooth receiver, a near field communication (NFC) antenna, a radio antenna (e.g., for Wi-Fi communications), or a global positioning system (GPS) receiver, etc. The communications interface 518 and/or the I/O device(s) 520 may enable the first user device 114 to obtain locality attributes.

Turning to the contents of the memory 510 in more detail, the memory 510 may include an operating system and one or more application programs or services for implementing the features disclosed herein, including a credential generation module 512. The credential generation module 512 may be responsible for generating a locality credential using one or more locality attributes. The locality credential may be generated by the credential generation module 512 based on one or more components (e.g., I/O devices 520, communication interface 518) the first user device 114 includes.

The one or more components of the first user device 114 may be used to obtain locality attributes to be used by the credential generation module 512 for generating the locality credential. Locality attributes may include information that can be used to identify a locality. In certain embodiments, the locality attributes may include any information obtained by the first user device 114. For example, the locality attributes may include at least one of: an image, a sound file, an atmospheric pressure reading, a temperature reading, a GPS location, a device identifier (e.g., a globally unique device identifier), a user identifier (e.g., a username), a password, a challenge response, information obtained from a device in a locality the resident device 104 can manage, etc.

It should be understood that one or more functions of the credential generation module 512 may be performed by the resident device 104, the remote server 522, and/or the verification device 116.

In some embodiments, the verification device 116 may be connected to the resident device 104 via network 508. The verification device 116 may include its own of any number of the components that the first user device 114 includes. For example, like the first user device 114, the verification device 116 may also include a memory that includes a credential generation module. The verification device 116 can also include processors, storage, a communications interface, and/or I/O devices.

In some embodiments, the environment device 118 may be connected to the resident device 104 via network 508. The environment device 118 may include its own of any number of the components that the first user device 114 includes. For example, like the first user device 114, the environment device 118 may also include a memory that includes a credential generation module. The verification device 116 can also include processors, storage, a communications interface, and/or I/O devices.

In some embodiments, as described above the remote server 522 may correspond to a cloud computing platform. The remote server 522 may perform one or more functions, including, for example: receiving a locality credential from the verification device 116, the first user device 114, and/or the resident device 104. The remote server 522 may include a locality verification system. The remote server 522 may include a credential generation module, I/O devices, and/or communications interfaces, etc.

Turning to the resident device 104 in further detail, the resident device 104 may be a computer system that comprises at least one memory 530, one or more processing units (or processor(s)) 546, a storage unit 548, a communication device 550, and an I/O device 552. In some embodiments, these elements may be implemented similarly (or differently) than as described in reference to similar elements of first user device 114. In some embodiments, the storage unit 408 may store an allow list (e.g., of users and/or devices), a block list (e.g., of users and/or devices) and/or permissions. The resident device 104 may be housed in any suitable unit (e.g., a smart TV, a smart speaker, etc.).

Turning to the contents of the memory 530 in more detail, the memory 530 may include an operating system 532 and one or more application programs or services for implementing the features disclosed herein, including a communications module 534, an encryption module 536, a notification management module 538, a profile management module 540, a scoring module 542, and a locality verification system 132.

The communications module 534 may comprise code that causes the processor 546 to generate messages, forward messages, reformat messages, and/or otherwise communicate with other entities. For example, the communications module 534 may receive (and/or transmit) locality credentials from the first user device 114, the verification device 116, and/or the remote server 522. The communications module 534 may also be responsible for receiving requests to control a resource (e.g., control the environment device 118). The communications module 534 may also be responsible for providing notifications. For example, the communications module 534 may transmit a notification message to the first user device 114 when the time to live of a locality credential associated with the first user device 114 and/or the user of the first user device 114 is set to expire. The communications module 534 may transmit a notification message to an owner of the resident device 104, an administrator of the locality, or another user device communicatively coupled with the resident device 104 that indicates access to a resource has been granted and/or restricted. In some embodiments, the communications module 534 may provide a notification using any suitable channel and/or to any suitable device. For example, the communications module 534 may provide an audible notification via a speaker I/O device 552 at a location within a home environment. In another example, the communications module 534 may provide an audiovisual notification to a smart TV within a home environment. For example, a PIP display of the smart TV may display a video feed from camera 504 (e.g., showing a user at the front door of a home). The smart TV may also announce who is at the door and/or allow two-way communication via a speaker and/or microphone I/O devices of the resident device 506.

The encryption module 536 may comprise code that causes the processor 546 to encrypt and/or decrypt messages. For example, the encryption module 536 may receive encrypted data (e.g., locality credentials, locality attributes) from the first user device 114, the remote server 522, and/or the verification device 116. The encryption module 536 may include any suitable encryption algorithms to encrypt data. Suitable data encryption algorithms may include Data Encryption Standard (DES), tripe DES, Advanced Encryption Standard (AES), etc. It may also store (e.g., in storage unit 548) encryption keys (e.g., encryption and/or decryption keys) that can be used with such encryption algorithms. The encryption module 536 may utilize symmetric or asymmetric encryption techniques to encrypt and/or verify data. For example, the first user device 114, the remote server 522, and/or the verification device 116 may contain similar code and/or keys as encryption module 536 that is suitable for encrypting/decrypting data communications with the resident device (and/or remote server 522).

The notification management module 538 may comprise code that causes the processor 546 to store and manage settings for providing notifications. The notification management module 538 may also be responsible for generating notifications that are provided by the communications module 534. It should be understood that a notification may presented in any suitable form (e.g., text, audio, video, and/or suitable combinations). In some embodiments, the notification management module 538 may be configured to performing no operation (e.g., a “no-op”) in a particular setting. For example, the resident device 104 may be configured to only provide AV-based notifications to user device 502 if a locality credential received is not associated with a user and/or device on an allow list. Accordingly, if the resident device 104 detects a locality credential received is associated with a user and/or device on an allow list, the notification management module 538 may determine to perform no operation (e.g., remaining silent, only logging the observation internally, etc.). In some embodiments, the notification management module 538 may also determine whether to provide notifications based on the time of day and/or the locality attributes received.

In certain embodiments, the resident device 104 includes a credential generation module.

The profile management module 540 may comprise code that causes the processor 546 to maintain and store profiles of users and/or user devices. For example, the profile management module 540 may receive users and/or devices to be included in an allow list or block list. The profile management module 540 may then be cross-referenced when a locality credential is received and associated with a user and/or user device. The profile management module 540 may also include information relating to which users and/or user devices have what permissions, when permissions are allowed (e.g., time of day, day of a week, a predefined single period of time), whether a notification should be generated, etc.

The scoring module 542 may comprise code that causes the processor 546 to determine a score that corresponds a locality credential and/or one or more locality attributes. The scoring module 542 may determine if a score of the locality credential and/or locality attributes the locality credential includes is above a threshold score in determining whether the locality credential is to be trusted. The locality credentials and/or locality attributes can cause certain devices (e.g., user devices, verification devices), users, and/or locality attributes to be trusted more than others. The score may be based on the number of locality attributes the locality credential includes, which locality attributes are included, the device that generated the locality credential, when the locality credential was generated, a software version that the device that generated the locality credential was running, etc.

In certain embodiments, a score is associated with a locality credential before the locality credential is received by the locality verification system. For example, the verification device may compute a score to be associated with the locality credential so that when the resident device and/or locality verification system receives the locality credential, processing to compute the score does not need to be performed. Such embodiments can distribute the score processing among devices.

The locality verification system 132 may comprise code that causes the processor 546 to determine whether a locality credential is trusted. Determining whether the locality credential is trusted may cause the scoring module 542 to be used. Operations of the locality verification system 132 have been described in detail herein. The verification device 116, the remote server 522, and/or the resident device 104 may include the locality verification system 106.

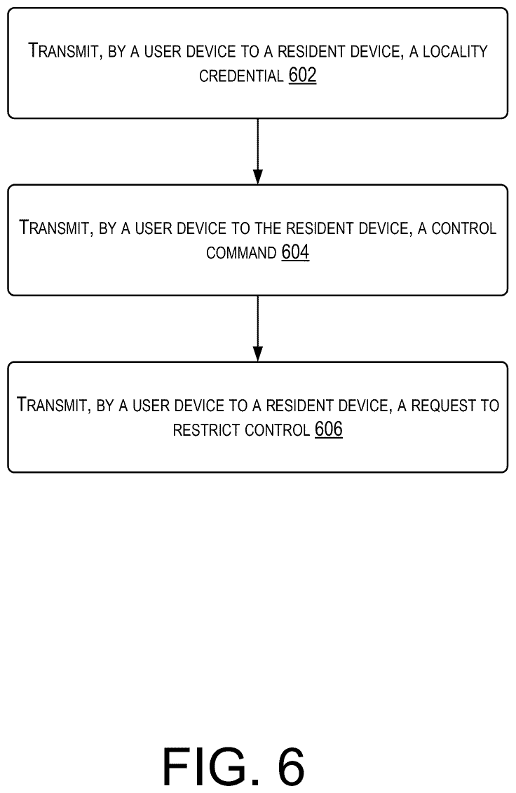

The processing depicted in FIGS. 6-8, and any other FIGS. may be implemented in software (e.g., code, instructions, program) executed by one or more processing units (e.g., processors, cores) of the respective systems, using hardware, or combinations thereof. The software may be stored on a non-transitory storage medium (e.g., on a memory device). The method presented in FIGS. 6-8, and other FIGS. and described herein are intended to be illustrative and non-limiting. Although FIGS. 6-8, and other FIGS., depict the various processing steps occurring in a particular sequence or order, this is not intended to be limiting. In certain alternative embodiments, the processing may be performed in some different order or some steps may also be performed in parallel. It should be appreciated that in alternative embodiments the processing depicted in FIGS. 6-8, and other FIGS. may include a greater number or a lesser number of steps than those depicted in the respective FIGS.

FIG. 6 is a simplified flow diagram illustrating an example process 600 performed by a user device to prove locality, according to some embodiments. The user device may perform the process 600 before access to a resource is permitted to obtain access to the resource. The user device may additionally or alternatively perform the process 600 after access to a resource is permitted to maintain the access to the resource.

At 602, the user device may transmit a locality credential to a resident device. The locality credential may be transmitted directly from the user device to the resident device (e.g., by using a Bluetooth communication or Wi-Fi communication between the resident device and the user device). The locality credential may be transmitted indirectly from the user device to the resident device (e.g., via a network connection to a server, via a verification device). The locality credential may include one or more locality attributes as described above.

At 604, the user device may transmit a control command to the resident device. The control command may request the resident device control one or more environment devices (e.g., on behalf of the user device). The control command may be useful for allowing the resident device to act as a central hub and not allowing the user device to directly control an environment device. In this manner, when the resident device is no longer communicatively coupled with the user device, the resident device determines not to trust the locality of the user device, and/or the resident device determines that no more user device commands will be carried out, the resident device can control whether an environment device can be and is controlled at the command of the user device.

At 606, the user device may transmit a request to restrict control to the resident device. The user device may transmit the request when the user device has left the locality or is leaving the locality. The user device may transmit the request based on user input to a user interface of the user device. The user device may transmit the request based on the user device determining the user device is no longer at the locality managed by the resident device.

Although process 600 describes the resident device receiving the locality credential and managing environment devices (e.g., controlling, restricting access to), one or more other devices (e.g., resident devices, servers, verification devices may be used to perform at least a portion of such functions.

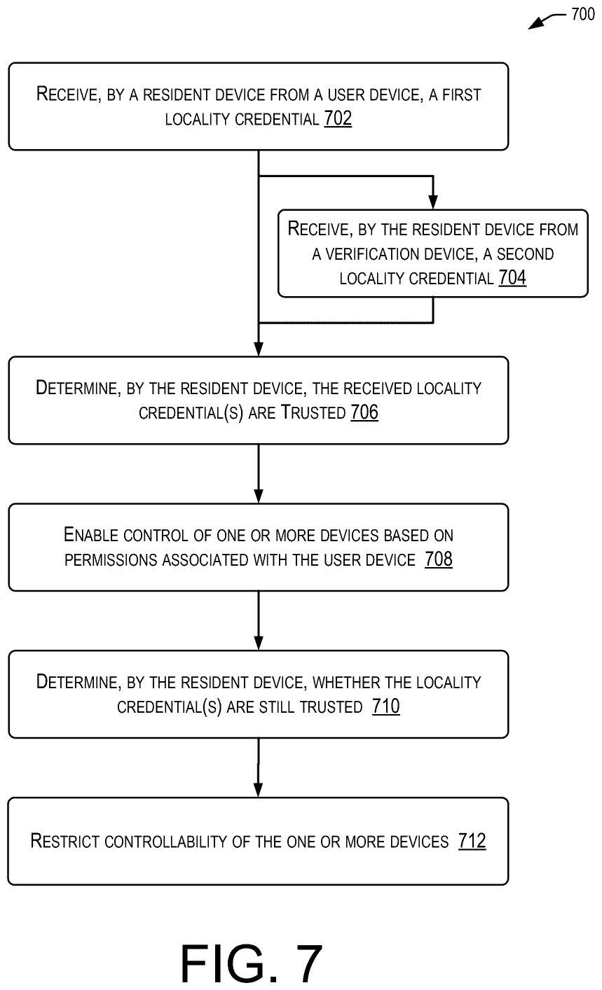

FIG. 7 is a simplified flow diagram illustrating an example process 700 performed by a resident device to manage access to a resource based on proof of locality, according to some embodiments. The resident device may perform the process 700 before access to a resource is permitted to a user device and/or a user. The resident device may additionally, or alternatively, perform the process 700 after a user device and/or a user is permitted access to a resource so that access to the resource may be maintained.

At 702, the resident device may receive a first locality credential. The resident device may receive the first locality credential directly or indirectly from the user device. In certain embodiments, the resident device receives the first locality credential regardless of whether the resident device includes a locality verification system. The first locality credential may have been generated by the user device as described herein.

At 704, it is illustrated that in certain embodiments, the resident device may receive a second locality credential directly or indirectly from a verification device. The resident device may receive the second locality credential directly or indirectly from a verification device in addition to as an alternative to the resident device receiving the first locality credential directly or indirectly from the user device. The second locality credential may have been generated by the verification device or received by the verification device as described herein.

At 706, the resident may determine whether the first locality credential and/or the second locality credential are trusted. The resident device can determine whether a locality credential is trusted using the locality verification system that the resident device may include or another device (e.g., a server) may include. The locality verification system may determine whether the first locality credential and/or the second locality credential are trusted. Determining whether any number of locality credentials are trusted can be performed according to the techniques described herein. The techniques may rely on the use of locality attributes, scoring, timestamps, allow lists, block lists, and other rules.

At 708, the resident device may permit access to one or more resources (e.g., enable control of one or more devices (e.g., an environment device)) based on permissions associated with the user and/or device associated with the first locality credential and/or the second locality credential. For example, the first user device may be associated with a user that wants to obtain access to a resource and therefore causes the first locality credential and/or the second locality credential to be generated and transmitted to the locality verification system. A user identifier may be associated (e.g., included in) with the first locality credential and/or the second locality credential (e.g., the user can be identified using the information included in the locality credential). The user identifier may be used to cross-reference an allow list of resources the user can access. For example, the user and/or user devices may have permission to unlock a first door but may not have permission to unlock a second door. The resident device may include the permissions associated with one or more users and/or user devices. The resident device may be capable of accessing (e.g., on a remote server) the permissions associated with one or more users and/or user devices. The resident device may access the permissions associated with one or more users to determine whether to permit the user and/or the user device access to one or more resources.

The resident device may send transmit commands to one or more devices (e.g., environment devices) based on whether a user and/or user device has caused a trusted locality credential to be provided to the locality verification system and the user and/or user device has permission to cause the command to be carried out. The resident device may act as a central command transmitter so that all command requests are received by the resident device and all commands transmitted to devices are sent by the resident device that has permissions to control the devices. Such a configuration can be useful to manage (e.g., permit, restrict) when resources (e.g., devices) can be accessed, what resources can be accessed, who can access resources.

At 710, the resident device and/or the locality verification system may determine whether one or more locality credentials associated with a user and/or user device are still trusted. For example, a trusted locality credential may include and/or be associated with a time to live. When the time to live expires, the user and/or user device associated with the locality credential may have their resource access restricted until one or more new locality credentials associated with the user are transmitted to the locality verification system and determined to be trusted.

In certain embodiments, the time to live of a locality credential can be extended or refreshed while the time to live as not expired. The time to live may be expired or refreshed based on one or more locality credentials being transmitted to the locality verification system. In certain embodiments, the time to live can be passively refreshed or extended by the resident device causing the time to live to be extended or refreshed after the resident device carries out a command based on a request from the user device and/or user. The request from the user device and/or user may indicate the user is still within the locality that the locality credential is associated with.

At 712, access to one or more resources may be restricted by the resident device. The resident device may restrict access to resources based on a restriction request being received from the user device and/or user the resource access is granted to, by a resource administrator (e.g., homeowner, network administrator, security personnel, etc.), or based on the time to live of a locality credential expiring. Access to the resource may be restricted from being accessed by one or more users and/or user devices until one or more users and/or user devices cause a locality credential to be generated and transmitted to the locality verification system and the locality verification system determines the locality verification credential is trusted.

In certain embodiments, access to one or more resources may be restricted by the resident device after all devices and/or users associated with locality credentials have left the locality. In certain embodiments, access to one or more resources may be restricted by the resident device after all locality credentials that were trusted by the verification system have an expired time to live. Such embodiments may be useful where the resource being accessed is not specific to a certain user or user device. For example, the resource being accessed may be disarming an alarm system. In such embodiments, the alarm system could stay disabled until all users have left the locality.

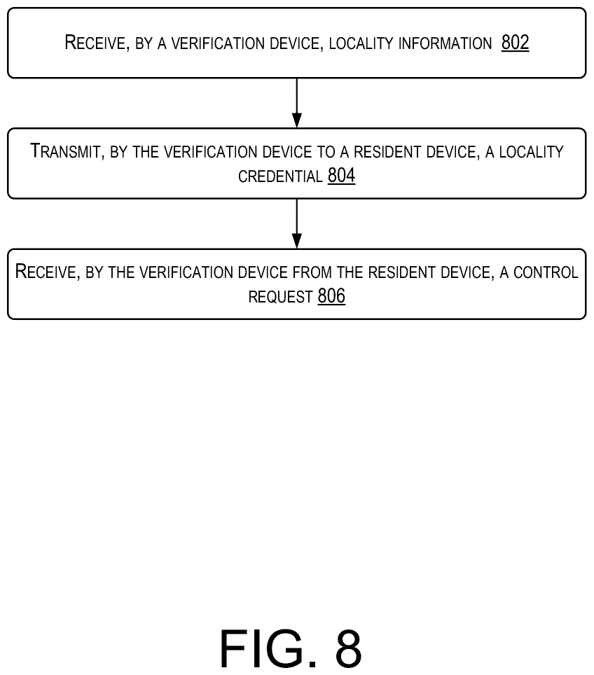

FIG. 8 is a simplified flow diagram illustrating an example process 800 performed by a verification device to verify a locality, according to some embodiments. The verification device may perform the process 800 before access to a resource is permitted to a user device and/or user to obtain access to the resource. The verification device may additionally or alternatively perform the process 800 after a user device and/or user is permitted access to a resource so that access to the resource may be maintained.

At 802, the verification device may receive locality information. The verification device may receive the locality information from one or more of the components the verification device includes. In certain embodiments, the verification device receives the locality information using one or more components that are not communicatively coupled with the user device and/or do not depend on communication with the user device. For example, the verification device may receive the locality information from a camera, a microphone, or a biometric sensor that the verification device includes. Such embodiments may be useful when information is being gathered about a user's locality.

In certain embodiments, the verification device receives locality information from the user device. For example, the user device may transmit an NFC signal to the verification device or a Bluetooth signal to the verification device. In an example, the user device may transmit a locality credential to the verification device. The locality credential may include one or more locality attributes.

At 804, the verification device may transmit a locality credential to a locality verification system. The locality credential may be a locality credential generated by a user device and received from the user device. The locality credential may be generated by the verification system.

A resident device may include the locality verification system. In certain embodiments, a server, the verification device, and/or another verification device include the locality verification system. In certain embodiments, even if the locality verification system is not included in the resident device, the locality credential may be transmitted from the verification device to the resident device to be forwarded to another device such that the locality credential can be transmitted to the locality verification system.

At 806, the verification device may receive a control request from the resident device. For example, the verification device may include an environment device that is being controlled by the resident device after a locality credential has been determined to be trusted by the locality verification system.

In certain embodiments, the verification device is controlled by the resident device based on a locality credential being determined as not trusted by the locality verification system. For example, the verification device may be controlled to make a sound or display a message (e.g., “not authorized to access”).

In certain embodiments, the process 800 is partially or completely performed by one or more other devices other than the verification device. For example, the verification device may include an environment device. In certain embodiments, the verification device is communicatively coupled with the resident device via a wired and/or wireless connection. The verification device may be communicatively coupled directly (e.g., no intermediate network hops) with the resident device and/or locality verification system and/or indirectly (e.g., one or more intermediate network hops) communicatively coupled directly with the resident device and/or locality verification system. In certain embodiments, the resident device does not include the locality verification system. In certain embodiments, a server includes the locality verification system.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A computer-implemented method, comprising:
receiving, by a first device connected to a network from a user device, a first locality credential indicating that the user device is within a first locality;
obtaining, by the first device, a second locality credential indicating that the user device is within a second locality;
determining, by the first device, whether the first locality credential is trusted based at least in part on a comparison of the first locality to the second locality; and
in accordance with a determination that the first locality credential is trusted, enabling, by the first device, the user device to access the network associated with the first device.

2. The computer-implemented method of claim 1, wherein the first locality credential is trusted in accordance with the first locality being a same location as the second locality.

3. The computer-implemented method of claim 1, wherein the first locality credential is not trusted if the first locality is not a same locality as the second locality; and
wherein the method further comprises in accordance with a second determination that the first locality credential is not trusted, disabling, by the first device, the access to the network.

4. The computer-implemented method of claim 1, wherein the first device manages the access to a third device that is connected to the network;
wherein the third device is accessed by the first device in accordance with the determination that the first locality credential is trusted; and
wherein the second device is located at a known second locality indicated by the second locality credential.

5. The computer-implemented method of claim 1, further comprising:
determining, by the first device and before the network is accessed by the user device via the network, whether the second locality credential is trusted.

6. The computer-implemented method of claim 1, further comprising:
receiving, by the first device, an indication that the user device has left the first locality; and
after receiving the indication that the user device has left the first locality, disabling, by the first device, the access of the user device to the network.

7. The computer-implemented method of claim 1, further comprising:
in further accordance with determining that the first locality credential is trusted, setting a time to live, wherein the network is accessible until the time to live expires;
receiving, by the first device, a third locality credential; and
adjusting the time to live.

8. The computer-implemented method of claim 1, wherein in accordance with the determination that the first locality credential is trusted, enabling, by the first device, the user device to access a third device via the network, wherein the third device comprises a smart accessory configured as at least one of: a television, an audio device, a light fixture, a garage door opener, an architectural covering, a camera, a lock, an alarm system, or an air conditioning unit.

9. The computer-implemented method of claim 1, wherein the first locality credential is associated with a score and the first locality credential is trusted if the score is above a predefined threshold score.

10. The computer-implemented method of claim 1, wherein the first locality credential or the second locality credential is received using infrared communication or radio communication.

11. A first device, comprising:
a memory configured to store computer-executable instructions; and
one or more processors in communication with the memory and configured to access the memory and execute the computer-executable instructions to, at least:
receive by the first device connected to a network from a user device, a first locality credential indicating that the user device is within a first locality;
obtain, by the first device, a second locality credential indicating that the user device is within a second locality;
determine, by the first device, whether the first locality credential is trusted based at least in part on a comparison of the first locality to the second locality; and
in accordance with a determination that the first locality credential is trusted, enable, by the first device, the user device to access the network associated with the first device.

12. The device of claim 11, wherein the first locality credential is trusted in accordance with the first locality being a same location as the second locality.

13. The device of claim 11, wherein the first locality credential is not trusted if the first locality is not a same locality as the second locality; and
wherein the one or more processors are further configured to access the memory and execute the computer-executable instructions to:
in accordance with a second determination that the first locality credential is not trusted, disable, by the first device, access to a third device that is connected to the network associated with the first device.

14. The device of claim 11, wherein the first device manages the access to a third device that is connected to the network;
wherein the third device is accessed by the first device in accordance with the determination that the first locality credential is trusted; and
wherein the second device is located at a known second locality indicated by the second locality credential.

15. The device of claim 11, wherein obtaining the second locality credential comprises executing the computer-executable instructions to:
receive, by the first device, from a second device, the second locality credential.

16. One or more computer-readable storage media comprising computer-executable instructions that, when executed by one or more processors of a device, cause the one or more processors to perform operations comprising:
receiving, by a first device connected to a network from a user device, a first locality credential indicating that the user device is within a first locality;
obtain, by the first device, a second locality credential indicating that the user device is within a second locality;
determining, by the first device, whether the first locality credential is trusted based at least in part on a comparison of the first locality to the second locality; and
in accordance with a determination that the first locality credential is trusted, enabling, by the first device, the user device to access the network associated with the first device.

17. The one or more computer-readable storage media of claim 16, wherein the first locality credential is trusted in accordance with the first locality being a same location as the second locality.

18. The one or more computer-readable storage media of claim 16, wherein the first device manages the access to network; and
wherein the second device is located at a known second locality indicated by the second locality credential.

19. The computer-implemented method of claim 16, wherein the first locality credential includes at least one of: a first coordinate, first image data, a first device identifier, a first locality credential identifier, a first user identifier, a first timestamp, a first indication of a type of communication, or first sound data, and wherein the second locality credential includes at least one of a second coordinate, second image data, a second device identifier, a second locality credential identifier, a second user identifier, a second timestamp, a second indication of a type of communication, or second sound data.

20. The computer-implemented method of claim 16, wherein the first locality credential is received based at least in part on at least one of: a near-field communication (NFC) signal, a password entry, a personal identification number (PIN) entry, a Bluetooth signal, a Wi-Fi signal, or an out of band signal.
